(19) United States
(12) Patent Application Publication
(10) Pub. No.: US 2012/0303479 A1
(43) Pub. Date: Nov. 29, 2012

(54) ONLINE SHOPPING OPTIMIZATION SYSTEM

(75) Inventors: Patrick Derks, Seattle, WA (US); Darin Dishneau, Snoqualmie, WA (US)

(73) Assignee: MICROSOFT CORPORATION, Redmond, WA (US)

(21) Appl. No.: 13/116,044

(22) Filed: May 26, 2011

(51) Int. Cl. G06Q 30/00

(52) U.S. Cl. 705/26.8

(57) ABSTRACT

An online shopping optimization system takes a list of items a user wants to purchase by going to one more stores or vendors and identifies those local stores from which the user can make the purchases in an optimal manner in accordance with any criterion or criteria that the user desires. The vendors may have a physical presence that the user will visit to make the purchase. Alternatively, one or more of the vendors may be online vendors. In operation, a user enters a search query through a web browser. The search query includes an identification of two or more products that a buyer wishes to purchase, from, e.g., one or more local vendors by visiting their respective premises. The search query also includes one or more criteria that are to be optimizing when establishing a shopping list which includes the plurality of products. In response to the query, an online service returns to the user at least one optimized shopping list that identifies two or more vendors from which the desired products are collectively available. The optimized shopping list is a shopping list that most optimally satisfies the one or more criteria specified in the search query.

### BACKGROUND

Despite the growth in online shopping individuals still spend a considerable amount of time shopping at physically present (“brick and mortar) stores in their local neighborhood and their larger geographic region. However, it is often not sufficient for buyers to simply compare the price of a product at store A versus the same product at store B. Often many additional factors need to be taken into account. For instance, to save time, individuals will often attempt to consolidate their purchases from a relatively small list of vendors so that they do not have to visit any more vendors than necessary.

The process of making a shopping list can be relatively time-consuming, particularly as both the number of desired products and the criteria used to select those products increases. While price is often the most important criteria, there are also other factors that buyers take into consideration when determining the store or stores to visit such as their current location, their willingness to travel to multiple stores, the availability of preferred brands at certain stores and so on. Even if a buyer is willing to spend the time needed to determine which products to purchase and the stores they should be purchased from, the evaluation process can involve tradeoffs among many variables that can often be difficult for buyers to fully and accurately take into account. Accordingly, optimizing a shopping lost in accordance with a buyer's criteria and preferences can be a laborious, error prone and time-consuming task.

### SUMMARY

An online shopping optimization system takes a list of items a user wants to purchase by going, in one implementation, to one more local stores or vendors and identifies those local stores from which the user can make the purchases in an optimal manner in accordance with any criterion or criteria that the user desires. For instance, the user may wish to visit the least number of stores while also traveling the shortest total distance and paying the least amount of money. The user may also rank these criteria in order of importance. Once the system identifies the local stores or vendors from which the products may be obtained, the system can use various optimization techniques to select the most optimal set of stores that satisfies the user's criteria.

In some implementations, one of more of the vendors are web-based or other on-line vendors from which the buyer will purchase products without physically visiting the vendor's premises.

in one particular implementation, a user enters a search query through a web browser. The search query includes an identification of two or more products that a buyer wishes to purchase from one or more local vendors by visiting their respective premises. The search query also includes one or more criteria that are to be optimizing when establishing a shopping list which includes the plurality of products. In response to the query, an online service returns to the user at least one optimized shopping list that identifies two or more vendors from which the desired products are collectively available. The optimized shopping list is a shopping list that most optimally satisfies the one or more criteria specified in the search query.

This summary is provided to introduce simplified concepts for managing an immerse environment that are further described below in the Detailed Description. This summary is not intended to identify essential features of the claimed subject matter, nor is it intended for use in determining the scope of the claimed subject matter.

### BRIEF DESCRIPTION OF THE DRAWINGS

FIG. 1 illustrates one example of an online shopping optimization system.

FIGS. 2 and 3 show an example of a client interface that may be presented to buyers by the web server cluster on the display of their network-enabled devices.

FIG. 4 is a flowchart illustrating one example of a method for creating a shopping list of products that a buyer can purchase by visiting the stores or other premises of a plurality of vendors.

### DETAILED DESCRIPTION

An online shopping optimization system can quickly and accurately develop a shopping list that allows buyers to visit and purchase products or other goods from stores in a manner that is optimized in accordance with any criteria they wish. For example, the shopping list may be developed to minimize the total price of the goods, the number of stores that need to be visited to purchase all the items on the shopping list and/or the total travel distance needed to visit all of the stores. For example, the buyer would input their flexibility to travel (e.g., a 5 mile radius from their current location) and how flexible they are to cost, product type (e.g., organic vs. non-organic and so on. The optimization system would use this information to build a list of stores that can adequately fulfill the buyers list of items based on their configuration. In some cases a single optimized shopping list will be provided to the buyers, whereas in other cases two or more shopping lists are provided which are each differently optimized.

For purposes of illustration only the following discussion and examples will be presented in the context of vendors who maintain a physical (“brick and motor”) store or other presence that the buyer intends to visit in order to obtain the products on the shopping list. More generally, however, the methods, techniques and systems discussed herein are equally applicable to web-based or other on-line vendors from which the buyer will purchase products without physically visiting the vendor's premises. In some particular implementations the shopping list may include both vendors who have a physical premises that the buyer will visit and vendors from which the buyer will purchase products online. Of course, some vendors may have both a physical presence locally accessible to the buyer and an on-line presence front which they can purchase products directly.

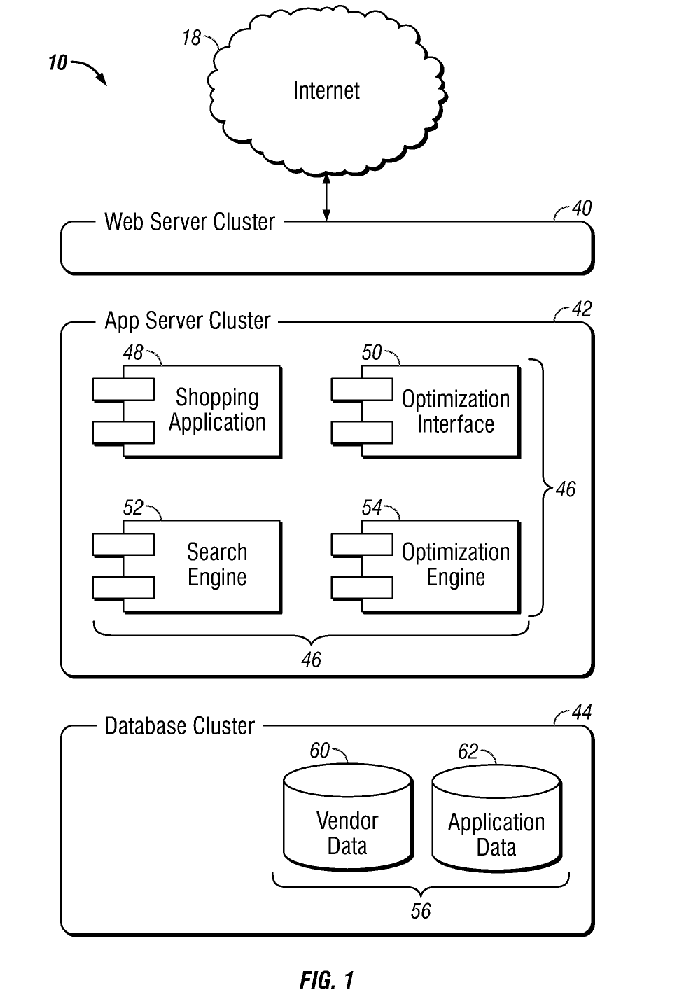

FIG. 1 illustrates one example of an online shopping optimization system 10. A user accesses the system 10 over a communications network such as the Internet using any appropriate network-enabled device such as a personal computer, a mobile communications device (e.g., a smartphone) and the like. The system 10 may be maintained by one or more vendors or a third party that retrieves information from one or more vendors.

The online shopping optimization system 10 typically includes one or more physical server computers with one or more physical storage devices and databases as well as various processing engines. Of course, the system 10 may include a number of other devices and databases not shown in FIG. 1. As shown, system 10 includes a web server cluster 40 operatively connected to an application server cluster 42. Each cluster represents one or more physical servers and devices. Additionally, in some implementations the functionality of different clusters may be combined into one or more physical servers. In this example web server cluster 40 serves as a web portal server through which users can access and interact with the system 10, thereby providing a single front-end interface that is accessed by a client-based application such as a conventional web browser.

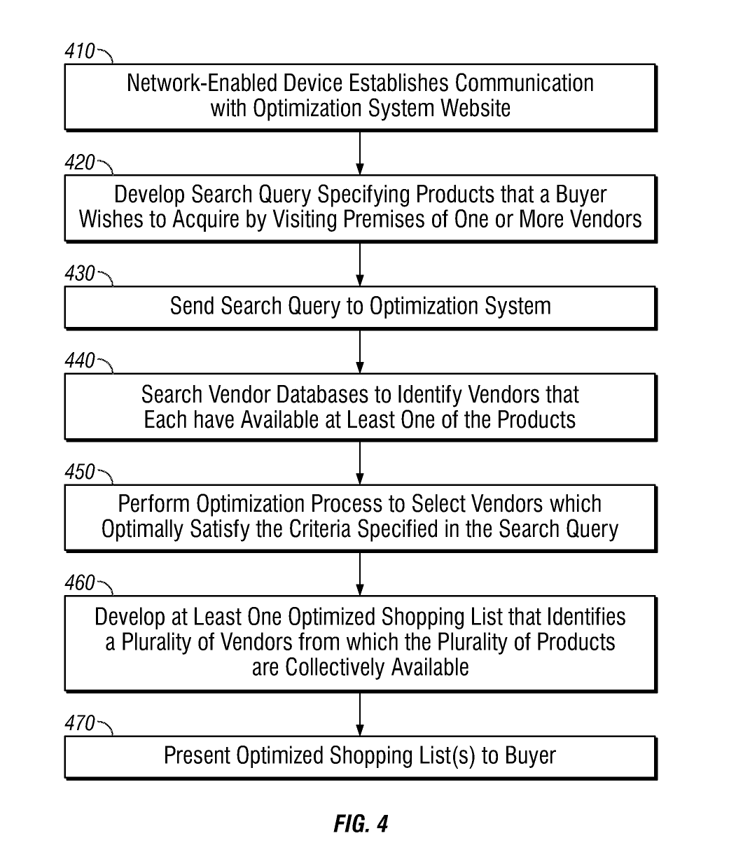

The logical architecture of application server cluster 42 may comprise one or more modules 46 to perform the method described below in connection with FIG. 4. These modules may be a shopping application 48, an optimization interface 50, a search engine 52, and an optimization engine 54. Logical modules 46 may be located within one processing device or may be distributed over more than one processing device, which may be co-located with one another or in communication with one another over a communications network (e.g., a LAN or WAN).

Both clusters 40 and 42 are operatively connected to database cluster 44. Database cluster 44 includes an application database 62 for storing profile information concerning the buyers. Database cluster 44 also includes a vendor database 60 for storing profile information concerning vendors who are registered with the system. The information stored in database cluster 44 can be used by the search engine 52 to facilitate the search process and, for example, to maintain pertinent information (e.g., their location) about the buyers so that buyers do not have to reenter the information each and every time. As with the modules 46, the databases 56 may be distributed over multiple devices that are in communication with one another over a communications network (e.g., a LAN or WAN).

In operation, a buyer visits a website hosted by web server cluster 40. The buyer uses the website to search for a number of items offered by local vendors at their respective stores. That is, the buyer may initiate a session to develop a shopping list by performing a search for the desired items through the use of search engine 52.

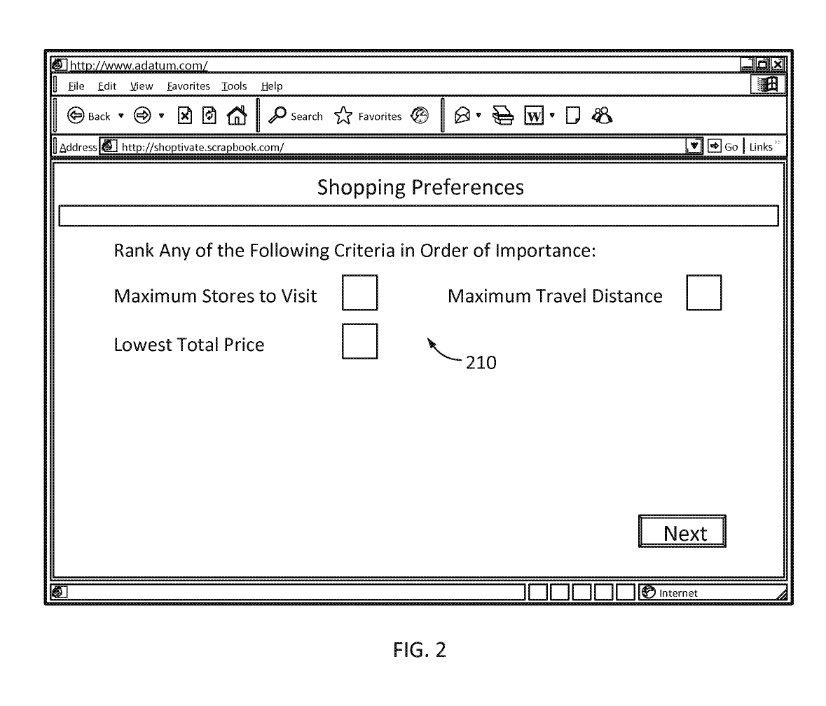

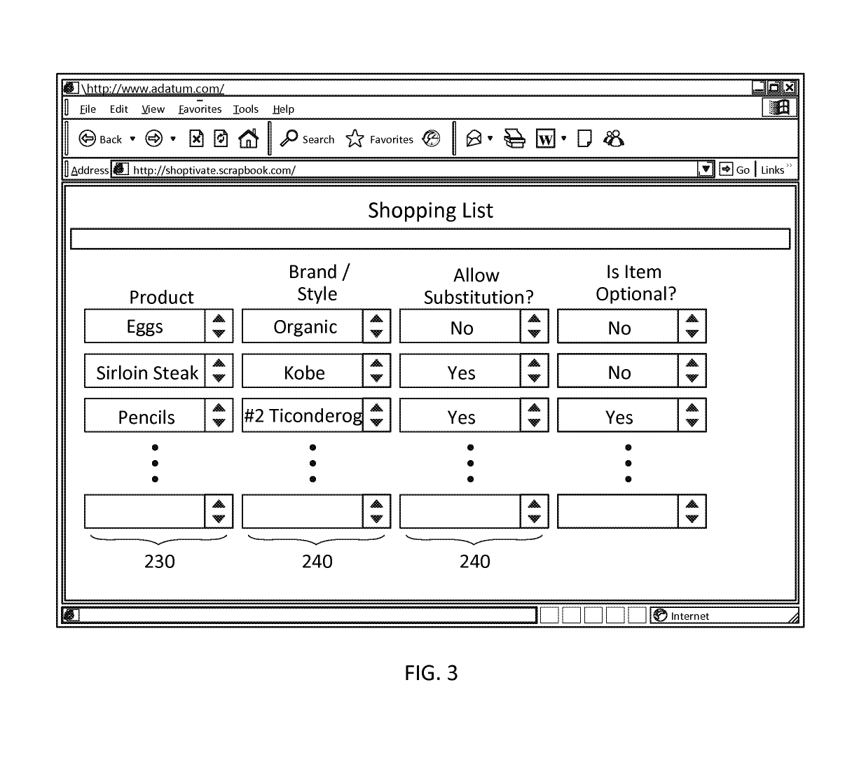

FIGS. 2 and 3 show an example of a client interface that may be presented to buyers by the web server cluster 40 on the display of their network-enabled devices. The interface presents a variety of fields that a buyer can populate to create a shopping list. The buyer may populate the fields in a variety of different ways depending on the particular configuration of the interface. For instance, depending on the field, the buyer may select from a pull down menu, enter a search term, or select/deselect a radio button. FIGS. 2 and 3 represent only one of a myriad of different ways in which such an interface may be configured.

The user interface in FIG. 2 presents the buyer with a list of criteria 210 that are to be taken into account when creating the shopping list. Each criterion may be given a numerical rank so that the buyer can select and rank a number of different criteria 210. Any criterion that is not ranked does not need to be taken into account. Illustrative criteria may include the maximum number of stores to be visited, the maximum total travel distance and the lowest total price. After entering their preferences in the user interface of FIG. 2, the user selects the ‘Next” icon and turns to FIG. 3. The user interface in FIG. 3 allows the user to formulate the shopping list, while selecting such product attributes as brand preferences and product type or style.

As shown in FIG. 3, the buyer can specify the products 230 that are to be included on the shopping list, along with various product attributes 240 that may also be specified. Such attributes may include, for each specified product, a preferred brand, a type or style of product, an indication of whether substitutions are allowed in the event that the specific product is not available, and whether the product is optional (so that, for instance, it can be removed from the shopping list if its inclusion would substantially worsen any of the specified criteria). If a pull down menu is employed for some or all of the product attribute fields, they may be context sensitive so that they are appropriate for each given product that is specified.

The fields in FIG. 2 have been populated with sample buyer input information to illustrate the manner in which they may be used. As shown, in this example the user desires to purchase three products: eggs, sirloin steak and pencils. The buyer in this case has not specified any brand of eggs, but does require them to be organic. Moreover, substitutions will not be allowed (e.g., non-organic eggs cannot be considered) and the item is not an optional purchase. In regard to sirloin steak, the buyer has specified Kobe beef with substitutions allowable regular beef if Kobe not available) In regard to the pencils, the buyers has specified that they should be number 2, pre-sharpened pencils produced by Ticonderoga. In this case, however, substitutions are allowed differently branded or unsharpened pencils). The criteria selected by the buyer, in decreasing order of priority, are low price and shorter travel distance.

In order to create the shopping list, the online shopping optimization system 10 uses the information provided by the buyer through the interface shown in FIG. 2 as well as additional information regarding buyer preferences that are not specific to any one shopping list. This additional information may include, for example, a default starting location, a list of preferred vendors and/or vendors to be avoided, any member or discount cards associated with any vendors, and so on. Although this information may be provided by the buyer through the user interface shown in FIG. 2 at the time a shopping list is to be created, it may be more convenient for the buyer to enter this information once (e.g., at the time of registration) and then store it in application database 62. In this way the buyer does not need to enter this information each and every time.

After the user has provided the information in FIG. 2, the search engine 52 of FIG. 1 conducts a search of vendor databases to locate the items on the shopping list. The search engine 52 will search vendors in the buyer's geographic area to identify stores which have available the items on the shopping list. The search engine 52 locates the identical items that are requested (where possible) and any substitutable items allowed by the buyer, as indicated by the information provided through the user interface of FIG. 2. In addition to performing a search, the optimization interface 50 extracts the information that is needed to perform the optimization process. This information includes, for example, the prioritized criteria provided by the buyer in FIG. 2 and any other constraints or information to be used during the optimization process which may be included in the buyer's profile stored in application database 62.

The search results obtained by the search engine 52 and the information extracted by optimization interface 50 are passed to optimization engine 54. The optimization engine 54 uses this information to create an optimized shopping list that best meets the buyer's criteria. The optimization engine 54 may formulate the optimization problem and perform the optimization process using any of a variety of different optimization techniques available to those of ordinary skill in the art.

One or more optimal solutions (i.e., shopping lists) developed by the optimization engine 54 are provided to the shopping application 48. The shopping application 48, in turn, presents one or more of the optimal solutions to the buyer as optimized shopping lists. For example, the shopping application 48 may present the three most optimal solutions. The shopping application 48 may allow the buyer to compare the different solutions to determine which shopping list is the most appropriate. The resulting shopping lists may be ranked by various characteristics, such as by information representative of the buyer's desired objective, such as the total cost of each list, the total number of stores to be visited and/or the total distance traveled. If the buyer is not satisfied with any of the solutions, the buyer may interact with the system by giving instructions to revise them. This may include searching for additional items, providing additional constraints, or selecting a different problem to be solved.

FIG. 4 is a flowchart illustrating one example of a method for creating a shopping list of products that a buyer can purchase by visiting the stores or other premises of a plurality of vendors. The method begins at step 410 when an optimization system sends a user interface a web page) to a buyer's network-enabled device over a communications network. In step 420 the user develops a search query that includes an identification of a plurality of products that a buyer wishes to purchase from one or more local vendors by visiting their respective premises. The search query further includes one or more criteria that are to be optimizing when establishing a shopping list which includes the plurality of products. The search query is sent to the optimization system at step 430. The optimization system searches vendor databases over the communications network in step 440 to identify one or more vendors that each have available at least one of the products. In step 450 the system performs an optimization process to select vendors that collectively have all the requested products and which more optimally satisfies the criteria specified in the search query. The system then develops in step 460 at least one optimized shopping list that identifies a plurality of vendors from which the plurality of products are collectively available. The optimized shopping list is a shopping list of products that most optimally satisfies the one or more criteria specified in the search query. In step 470, the optimized shopping list(s) is presented to the buyer. In some cases two or more shopping lists are presented to the buyer, each representing solutions that most optimally satisfy the one or more criteria specified in the search query from among all solutions developed during the optimization procedure.

As noted above, while the aforementioned examples refer to vendors who maintain a physical store or other presence that the buyer intends to visit in order to obtain the products on the shopping list, the methods, techniques and systems discussed herein are equally applicable to web-based or other online vendors from which the buyer will purchase products without physically visiting the vendor's premises.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application finning on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications may be made to this configuration without departing from the scope or spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for creating a shopping list of products to be obtained from a plurality of vendors, comprising:
receiving over a communications network a search query that includes an identification of a plurality of products that a buyer wishes to purchase from one or more vendors, said search query further including one or more criteria that are to be optimized when establishing a shopping list which includes the plurality of products;
developing at least one optimized shopping list that identifies a plurality of vendors from which the plurality of products are collectively available, said optimized shopping list being a shopping list that most optimally satisfies the one or more criteria specified in the search query; and
presenting the at least one optimized shopping list to the buyer.

2. The method of claim 1 wherein the one or more vendors each have a physical premises that the buyer will visit to obtain the plurality of products.

3. The method of claim 1 wherein at least one of the vendors is an on-line vendor from which the buyer will obtain at least one of the products.

4. The method of claim 1 wherein the search query further includes one or more attributes and/or constraints associated with at least one of the products that are to be satisfied when developing the optimized shopping list.

5. The method of claim 4 wherein at least one of the constraints allows or disallows an item to be substituted for a product included on the shopping list.

6. The method of claim 4 wherein at least one of the attributes of one of the products is a product brand and/or a product type.

7. The method of claim 2 wherein the one or more criteria require minimizing a total price and minimizing a number of different vendors to be visited to purchase all the products included on the shopping list.

8. The method of claim 2 wherein the one or more criteria require minimizing a total price and a total travel time or distance needed to purchase all of the products included on the shopping list.

9. The method of claim 1 further comprising searching vendor databases over the communications network to identify the two or more vendors that have the products available for purchase.

10. The method of claim 9 further comprising identifying two or more vendors that each have available at least one of the products and performing an optimization process to select one of the two or more vendors in order to most optimally satisfy the one or more criteria specified in the search query.

11. The method of claim 1 further comprising presenting a plurality of optimized shopping lists to the buyer, said plurality of shopping lists representing those solutions that most optimally satisfy the one or more criteria specified in the search query from among all solutions developed during the optimization procedure.

12. The method of claim 1 in which the one more criteria are presented in rank order and further comprising developing the at least one shopping least by optimizing the one or more criteria in accordance with the rank order.

13. A system for creating a shopping list of products to be purchased from a plurality of vendors at their respective premises, comprising:
a front-end server configured to receive over a communications network a search query that includes an identification of a plurality of products that a buyer wishes to purchase from one or more local vendors by visiting their respective premises, said search query further including one or more criteria that are to be optimizing when establishing a shopping list which includes the plurality of products;
an application server configured to develop at least one optimized shopping list that identifies a plurality of vendors from which the plurality of products are collectively available, said optimized shopping list being a shopping list that most optimally satisfies the one or more criteria specified in the search query.
presenting the at least one optimized shopping list to the buyer.

14. The system of claim 13 in which the front-end server is configured to present a user interface to the buyer over the communications network for entering the plurality of products and the one or more criteria.

15. The system of claim 13 in which the front-end server is further configured to receive a search query that further includes one or more attributes and/or constraints associated with at least one of the products that are to be satisfied when developing the optimized shopping list.

16. The system of claim 13 in which the application server includes an optimization engine configured to perform an optimization process that develops a plurality of shopping lists representing those solutions that most optimally satisfy the one or more criteria specified in the search query from among all solutions developed during the optimization procedure.

17. The system of claim 13 in which at least one of the constraints allows or disallows an item to be substituted for a product included on the shopping list.

18. One or more computer-readable storage media containing instructions which, when executed by one or more processors disposed in an electronic device having a portable power supply, perform a method comprising the steps of:
sending over a communications network a search query that includes an identification of a plurality of products that a buyer wishes to obtain from one or more local vendors by visiting their respective premises, said search query further including one or more criteria that are to be optimizing when establishing a shopping list which includes the plurality of products; and
receiving over the communications network at least one optimized shopping list that identifies a plurality of vendors from which the plurality of products are collectively available, said optimized shopping list being a shopping list that most optimally satisfies the one or more criteria specified in the search query.

19. The computer readable-storage media of claim 18 further comprising receiving over the communications network a user interface over the communications network through the buyer enters the plurality of products and the one or more criteria, said user interface including a web page provided by a website.

20. The computer readable-storage media of claim 18 further comprising:
sending over the communications network a plurality of criteria included with the search query, said criteria being presented in rank order; and
receiving the at least one optimized shopping list that most optimally satisfies the plurality of criteria in the rank order.
